(19) United States
(12) Patent Application Publication
(10) Pub. No.: US 2021/0294471 A1
(43) Pub. Date: Sep. 23, 2021

(54) IMAGE FORMING METHOD AND APPARATUS AND MOBILE TERMINAL

(71) Applicant: Sony Mobile Communications Inc., Tokyo (JP)

(72) Inventor: Chu-Hsin CHENG, Taiwan (CN)

(73) Assignee: Sony Mobile Communications Inc., Tokyo (JP)

(21) Appl. No.: 17/265,519

(22) PCT Filed: Aug. 14, 2018
(86) PCT No.: PCT/CN2018/100455

§ 371 Date: Feb. 3, 2021

(51) Int. Cl. G06F 3/0484; H04L 29/08; G06F 17/00; H04M 1/72451

(52) U.S. Cl. CPC G06F 3/0484; H04M 1/72451; G06F 17/00; H04L 67/18

(57) ABSTRACT

an image forming method and device, and a mobile terminal are disclosed. The image forming method comprises: a mobile terminal determines search information correlated with the current date according to calendar information; searches for one or more images from an image library according to the search information; and obtains an image file correlated with the current data according to the one or more images. Therefore, an image file correlated with the current data can be actively generated according to calendar information, and a mobile terminal can recommend the image file to a user and remind the user of the current date, thereby further improving the user experience.

### TECHNICAL FIELD

Embodiments of this disclosure relate to the field of image processing technologies, and in particular, to an image forming method and apparatus and a mobile terminal.

### BACKGROUND

Mobile terminals (such as smart phones, and tablets, etc.) have been widely used, and various mobile operating systems, such as IOS, and Android, etc., have been developed on mobile terminals. And various applications (or APP, for short) may operate on these mobile operating systems, thereby achieving a variety of powerful functions.

In addition, a camera function of a mobile terminal is also becoming more and more powerful, and a user may take a picture or video and store it in the mobile terminal to form an image library. And furthermore, for pictures or videos in the image library in the mobile terminal, sorting may be performed, or image annotation or the like may be performed.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in an existing mobile terminal, a function of browsing pictures or videos is generally provided to users, but pictures or videos are not actively recommended to the users. If a user hopes to transmit a picture or video to a relative or friend on a specific day, the image library needs to be browsed and an appropriate picture or video needs to be found and then transmitted to the other party. And if the user forgets the specific day, the related image cannot be transmitted, which is regretful.

Addressed to at least one of the above problems, embodiments of this disclosure provide an image forming method and apparatus, and a mobile terminal.

According to a first aspect of the embodiments of this disclosure, there is provided an image forming method, including:

determining search information related to a current date by a mobile terminal according to calendar information;

searching out one or more images from an image library by the mobile terminal according to the search information; and

obtaining an image file related to the current date by the mobile terminal according to the one or more images.

In an embodiment, the method further includes:

receiving instruction information inputted by a user, and transmitting the image file to a file server, other mobile terminals or an email server, by the mobile terminal.

In an embodiment, the method further includes:

acquiring the calendar information by the mobile terminal locally or from a server.

In an embodiment, the current date includes at least one of the following: a festival or a holiday of a region where the mobile terminal is located, a memorial day or a celebration day of a user of the mobile terminal, a festival or a holiday of a preset region, and a memorial day or a celebration day of a preset person.

In an embodiment, the image comprises at least one of the following: a static picture, a dynamic picture, and a video; and the image file comprises at least one of the following: a picture file, a video file, an electronic greeting card, and an electronic display file.

In an embodiment, the method further comprises:

registering an image by the mobile terminal and/or a server to associate the registered image with the search information.

In an embodiment, the searching out one or more images from an image library by the mobile terminal according to the search information comprises:

determining a corresponding registered image by the mobile terminal according to the search information; and

performing image recognition in the image library according to the registered image so as to find out one or more images matching with the registered image.

In an embodiment, the searching out one or more images from an image library by the mobile terminal according to the search information comprises:

transmitting the search information and/or the corresponding registered image by the mobile terminal to the server, so that the server performs image recognition in the image library according to the registered image to which the search information corresponds, so as to find out one or more images matching with the registered image; and

receiving the one or more images matching with the registered image by the mobile terminal from the server.

In an embodiment, the method further comprises:

annotating images in the image library by the mobile terminal and/or the server.

In an embodiment, the searching out one or more images from an image library by the mobile terminal according to the search information comprises:

matching annotation information in the image library by the mobile terminal according to the search information; and

finding out one or more images corresponding to annotation information matching with the search information.

In an embodiment, the searching out one or more images from an image library by the mobile terminal according to the search information comprises:

transmitting the search information by the mobile terminal to the server, so that the server matches annotation information in the image library according to the search information, so as to find out one or more images to which annotation information matching with the search information corresponds; and

receiving one or more images corresponding to the annotation information matching with the search information by the mobile terminal from the server.

In an embodiment, the obtaining an image file related to the current date by the mobile terminal according to the one or more images comprises:

receiving instruction information inputted by the user, and selecting and/or editing the one or more images, by the mobile terminal; and

generating the image file according the one or more images and words and/or voices related to the current date that are inputted by the user or predetermined.

In an embodiment, the obtaining an image file related to the current date by the mobile terminal according to the one or more images comprises:

transmitting request information by the mobile terminal to the server, so that the server generates the image file according to the one or more images; and

receiving the image file related to the current date by the mobile terminal from the server.

According to a second aspect of the embodiments of this disclosure, there is provided an image forming apparatus, comprising:

an information determining unit configured to determine search information related to a current date according to calendar information;

an image searching unit configured to search out one or more images from an image library according to the search information; and

a file obtaining unit configured to obtain an image file related to the current date according to the one or more images.

In an embodiment, the apparatus further comprises:

a file transmitting unit configured to receive instruction information inputted by a user, and transmit the image file to a file server, other mobile terminals or an email server.

According to a third aspect of the embodiments of this disclosure, there is provided a mobile terminal, comprising a memory and a processor, the memory storing instructions executed by the processor, and the processor being configured to carry out the image forming method as described in the first aspect by executing the instructions.

According to a fourth aspect of the embodiments of this disclosure, there is provided a computer program, wherein when the program is executed in a mobile terminal, the program causes the mobile terminal to carry out the image forming method as described in the first aspect.

According to a fifth aspect of the embodiments of this disclosure, there is provided a storage medium storing a computer program, wherein the computer program causes a mobile terminal to carry out the image forming method as described in the first aspect.

An advantage of the embodiments of this disclosure exists in that the mobile terminal determines search information related to a current date according to calendar information, searches out one or more images from an image library according to the search information, and obtains an image file related to the current date according to the one or more images. Hence, the image file related to the current date may be actively generated according to the calendar information, and the mobile terminal may recommend and remind the current date to the user, thereby further improving user experiences.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of an image forming method of an embodiment of this disclosure;

FIG. 2 is another schematic diagram of the image forming method of the embodiment of this disclosure;

FIG. 3 is a further schematic diagram of the image forming method of the embodiment of this disclosure;

FIG. 4 is still another schematic view of the image forming method of the embodiment of this disclosure;

FIG. 5 is yet another schematic block diagram of the image forming method of the embodiment of this disclosure;

FIG. 6 is still another schematic block diagram of the image forming method of the embodiment of this disclosure;

FIG. 7 is a schematic diagram of an image forming apparatus of an embodiment of this disclosure; and

FIG. 8 is a block diagram of a mobile terminal of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

The interchangeable terms “mobile terminal” and “mobile device” include portable radio communication apparatuses. The term “portable radio communication apparatus”, which hereinafter is referred to as a “mobile radio terminal”, “portable electronic device”, or “portable communication device”, comprises all apparatuses such as mobile telephones, pagers, communicators, electronic organizers, personal digital assistants (PDAs), smartphones, media players, tablets, portable communication devices, portable game players, or the like.

In this disclosure, embodiments of this disclosure are described primarily in the context of a portable electronic device in the form of a mobile telephone (also referred to as “mobile phone”). However, it shall be appreciated that this disclosure is not limited to the context of a mobile telephone and may relate to any type of appropriate electronic apparatus, and examples of such electronic apparatus include digital single lens reflex cameras, digital mirrorless cameras, smartphones, tablets, portable digital cameras, media players, portable game players, PDAs, and computers, etc.

### Embodiment of the First Aspect

The embodiment of this disclosure provides an image forming method, applicable to the above-described mobile terminal. Following description shall be given by taking a smartphone as an example; however, this disclosure is not limited thereto.

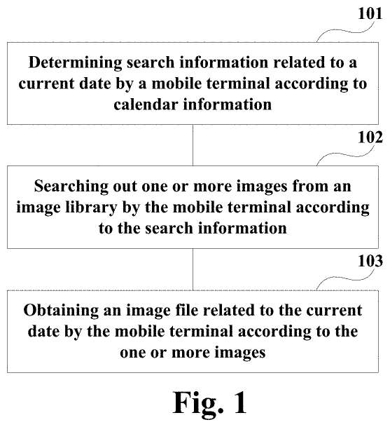

FIG. 1 is a schematic diagram of an image forming method of the embodiment of this disclosure. As shown in FIG. 1, the method includes:

step 101: determining search information related to a current date by a mobile terminal according to calendar information;

step 102: searching out one or more images from an image library by the mobile terminal according to the search information; and

step 103: obtaining an image file related to the current date by the mobile terminal according to the one or more images.

In an embodiment, the current date may include at least one of the following: a festival or a holiday of a region where the mobile terminal is located, a memorial day or a celebration day of a user of the mobile terminal, a festival or a holiday of a preset region, and a memorial day or a celebration day of a preset person; however, this disclosure is not limited thereto.

For example, if the mobile terminal is located in China, a festival or holiday of a region where the mobile terminal is located may include: Spring Festival, Tomb-sweeping Day, Dragon Boat Festival, Labor Day, and Mid-autumn Festival, etc., or Children's Day, Father's Day, Mother's Day, and the like. If the mobile terminal is located in the United States, a festival or holiday of an area where the mobile terminal is located may include: Christmas, Halloween, New Year's Day, Valentine's Day, April Fool's Day, Thanksgiving Day, or Father's Day, Mother's Day, and the like. However, this disclosure is not limited thereto, and different countries or regions may have different festivals or holidays.

For example, an anniversary or celebration date of the user of the mobile terminal may include: wedding anniversary, and birthday, etc. However, this disclosure is not limited thereto, and it may be other anniversary or celebration day. In addition, it may also be a festival or holiday of a predetermined region (for example, it may be predetermined as Hokkaido of Japan), or a commemoration day or a celebration day of a predetermined character (for example, Jesus).

In an embodiment, the calendar information may be stored locally on the mobile terminal, or may be stored in a server (e.g. one or more servers in cloud computing). The mobile terminal may determine the current date according to the obtained calendar information.

In an embodiment, the image may include at least one of the following: a static picture, a dynamic picture, and a video; and the image file may include at least one of the following: a picture file, a video file, an electronic greeting card, and an electronic display file. However, this disclosure is not limited thereto, and it may be any other file formats.

In an embodiment, the mobile terminal may receive instruction information inputted by a user, and transmit the image file to a file server, such as uploading to social software (e.g. SNS, WeChat, and Facebook, etc.); or the image file may be transmitted to a mail server; or the image file may be transmitted to a corresponding mail address; or the image file may be directly transmitted to other mobile terminals.

In an embodiment, the image library may include pictures or videos stored locally by the mobile terminal, or may include pictures or videos stored in a server (e.g. one or more servers in the cloud, a cloud disk or a network disk, etc.), and this disclosure is not limited thereto.

The embodiment of this disclosure shall be further described below by taking Father's Day as an example.

In one embodiment, the mobile terminal and/or the server may register an image (e.g. an image of a father) and associate the registered image with the search information (e.g. a father). And after being triggered to select an image, image recognition is performed in the image library according to the registered image, thereby generating an image file.

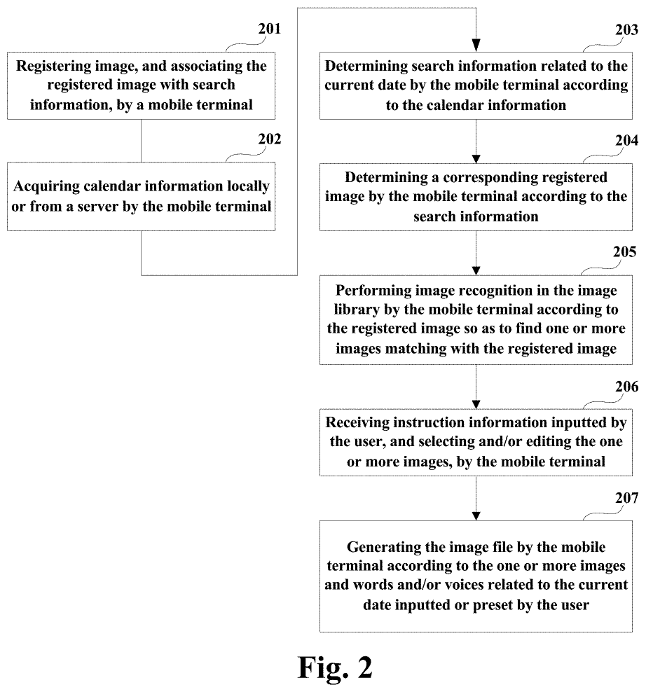

FIG. 2 is another schematic diagram of the image forming method of the embodiment of this disclosure, in which an example of performing image search and generating an image file in the mobile terminal (locally) is shown. As shown in FIG. 2, the method includes:

step 201: registering the image, and associating the registered image with the search information, by the mobile terminal;

for example, a father may be photographed by using the mobile terminal to obtain an avatar of the father and take the avatar as a registered image of the father; in addition, a number of photos or videos about the father may have been stored in the image library, such as a photo of the user and the father, a single photo of the father, and a photo of family members, etc.;

step 202: acquiring the calendar information locally or from the server by the mobile terminal;

in an embodiment, the mobile terminal may be triggered at a predetermined moment to select an image according to the calendar information. For example, it is triggered to determine a current date at 7:00 am every day, and at 7:00 am on the third Sunday of June 2018, the mobile terminal may determine that the current date is the Father's Day according to the calendar information;

step 203: determining search information related to the current date by the mobile terminal according to the calendar information;

for example, if the current date is Father's Day of 2018, it may be determined that the search information related to the current date is “father”; for another example, if the current date is a mother's birthday of 2018, it may be determined that the search information related to the current date is “mother”; and for a further example, if the current date is the Dragon Boat Festival of 2018, it may be determined that the search information related to the current date is “Zongzi”. However, this disclosure is not limited thereto, and a date and search information may be associated as actually demanded;

step 204: determining a corresponding registered image by the mobile terminal according to the search information;

step 205: performing image recognition in the image library by the mobile terminal according to the registered image so as to find one or more images matching with the registered image;

for example, according to the search information “father” determined in step 203, the mobile terminal may determine the registered image of the father registered in step 201, and then perform image matching in the image library according to the registered image, and reference may be made to related image recognition techniques for how to match; hence, one or more pictures or videos of “father” may be found;

step 206: receiving instruction information inputted by the user, and selecting and/or editing the one or more images, by the mobile terminal;

for example, in step 205, a plurality of photos of the user and the father may be found, and a predetermined number (for example, three) of images are recommended to the user according to a rule (such as a capture time, a capture location, and a capture parameter, etc.); the user may also select or replace these images, and furthermore, the user may edit them (such as adjusting brightness, and contrast, etc.);

step 207: generating the image file by the mobile terminal according to the one or more images and words and/or voices related to the current date inputted or preset by the user;

for example, the words and/or voices related to the current date inputted or preset by the user may include: words of “Happy Father's Day”, voice of “Happy Father's Day”, a favorite song of a father, and a song blessing a father, etc.; and the mobile terminal may synthesize these images, as well as these words and/or voices, and generate an electronic greeting card.

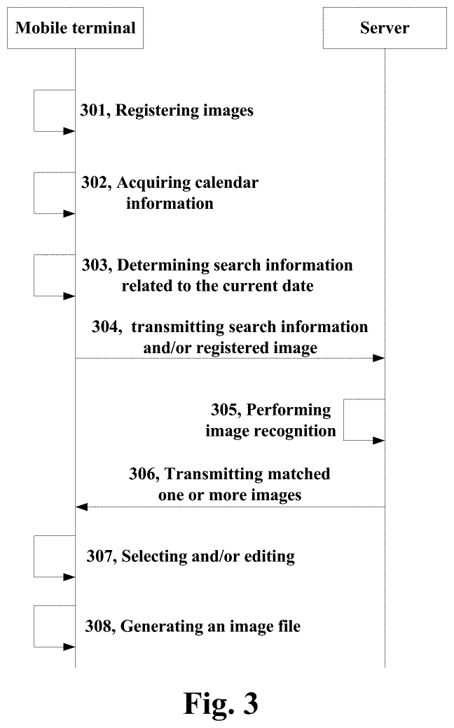

FIG. 3 is a further schematic diagram of the image forming method of the embodiment of this disclosure, in which an example of performing image search in the server (remotely) and generating a file in the mobile terminal (locally) is shown. As shown in FIG. 3, the method includes:

step 301: registering the image, and associating the registered image with the search information, by the mobile terminal and/or the server;

for example, a father may be photographed by using the mobile terminal to obtain an avatar of the father and take the avatar as a registered image of the father; at the server end, the registered image may be associated with the father; in addition, an image library (such as a cloud image library) may be located in the server, and image search is performed by the server; many photos or videos about the father, such as a photo of the user and the father, a single photo of the father, and a photo of family members, etc., may have been stored in the cloud image library;

step 302: acquiring the calendar information locally or from the server by the mobile terminal;

in an embodiment, the mobile terminal may be triggered at a predetermined moment to select an image according to the calendar information. For example, it is triggered to determine a current date at 7:00 am every day, and at 7:00 am on the third Sunday of June 2018, the mobile terminal may determine that the current date is the Father's Day according to the calendar information;

step 303: determining search information related to the current date by the mobile terminal according to the calendar information;

for example, if the current date is Father's Day of 2018, it may be determined that the search information related to the current date is “father”; for another example, if the current date is a mother's birthday of 2018, it may be determined that the search information related to the current date is “mother”; and for a further example, if the current date is the Dragon Boat Festival of 2018, it may be determined that the search information related to the current date is “Zongzi”. However, this disclosure is not limited thereto, and a date and search information may be associated as actually demanded;

step 304: transmitting the search information by the mobile terminal to the server, determining a corresponding registered image by the server according to the search information; and/or, determining a corresponding registered image by the mobile terminal according to the search information, and transmitting the registered image to the server;

step 305: performing image recognition in the cloud image library by the server according to the registered image so as to find one or more images matching with the registered image;

for example, the server performs image matching in the cloud image library according to the registered image, and reference may be made to related image recognition techniques for how to match; hence, one or more pictures or videos of “father” may be found in the cloud;

step 306: transmitting one or more images matching with the registered image by the server to the mobile terminal;

step 307: receiving instruction information inputted by the user, and selecting and/or editing the one or more images, by the mobile terminal;

for example, in step 305, a plurality of photos of the user and the father may be found, and the mobile terminal may recommend a predetermined number (for example, three) of images to the user according to a rule (such as a capture time, a capture location, and a capture parameter, etc.); the user may also select or replace these images, and furthermore, the user may edit them (such as adjusting brightness, and contrast, etc.);

step 308: generating the image file by the mobile terminal according to the one or more images and words and/or voices related to the current date inputted or preset by the user;

for example, the words and/or voices related to the current date inputted or preset by the user may include: words of “Happy Father's Day”, voice of “Happy Father's Day”, a favorite song of a father, and a song blessing a father, etc.; and the mobile terminal may synthesize these images, as well as these words and/or voices, and generate an electronic greeting card.

In an embodiment, the mobile terminal and/or the server may annotate images in the image library, and after being triggered to select an image, perform matching according to annotation information of the search information (such as “father”) in the image library, and then find a corresponding image (such as an image related to the father) according to a matching result, thereby generating the image file.

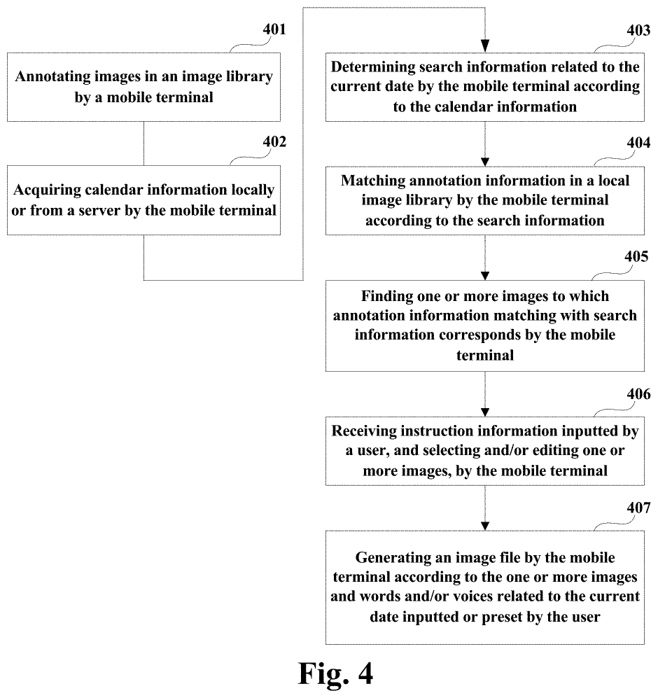

FIG. 4 is still another schematic diagram of the image forming method of the embodiment of this disclosure, in which an example of performing image search and generating an image file in the mobile terminal (locally) is shown. As shown in FIG. 4, the method includes:

step 401: annotating images in the image library by the mobile terminal;

for example, a father may be photographed by using the mobile terminal to obtain an avatar of the father and take the avatar as annotation information of the father; in addition, a number of photos or videos about the father may have been stored in the image library, such as a photo of the user and the father, a single photo of the father, and a photo of family members, etc.; and these images have been annotated, and the annotation information includes “father”; and of course, one image may be annotated with multiple key words;

step 402: acquiring the calendar information locally or from the server by the mobile terminal;

in an embodiment, the mobile terminal may be triggered at a predetermined moment to select an image according to the calendar information. For example, it is triggered to determine a current date at 7:00 am every day, and at 7:00 am on the third Sunday of June 2018, the mobile terminal may determine that the current date is the Father's Day according to the calendar information;

step 403: determining search information related to the current date by the mobile terminal according to the calendar information;

for example, if the current date is Father's Day of 2018, it may be determined that the search information related to the current date is “father”; for another example, if the current date is a mother's birthday of 2018, it may be determined that the search information related to the current date is “mother”; and for a further example, if the current date is the Dragon Boat Festival of 2018, it may be determined that the search information related to the current date is “Zongzi”. However, this disclosure is not limited thereto, and a date and search information may be associated as actually demanded;

step 404: matching annotation information in a local image library by the mobile terminal according to the search information;

step 405: find one or more images to which the annotation information matching with the search information corresponds by the mobile terminal;

for example, according to the search information “father” determined in step 403, if annotation information of an image in the local image library includes “father, Hokkaido, mother”, the image may be deemed as being matching with the search information as it includes “father”; hence, one or more images annotated with “father” may be matched in step 401, and reference may be made to related image annotation techniques for how to match;

step 406: receiving instruction information inputted by the user, and selecting and/or editing the one or more images, by the mobile terminal;

for example, in step 405, a plurality of photos of the user and the father may be found, and a predetermined number (for example, three; however, it is not limited thereto) of images are recommended to the user according to a rule (such as a capture time, a capture location, and a capture parameter, etc.); the user may also select or replace these images, and furthermore, the user may edit them (such as adjusting brightness, and contrast, etc.);

step 407: generating the image file by the mobile terminal according to the one or more images and words and/or voices related to the current date inputted or preset by the user;

for example, the words and/or voices related to the current date inputted or preset by the user may include: words of “Happy Father's Day”, voice of “Happy Father's Day”, a favorite song of a father, and a song blessing a father, etc.; and the mobile terminal may synthesize these images, as well as these words and/or voices, and generate an electronic greeting card.

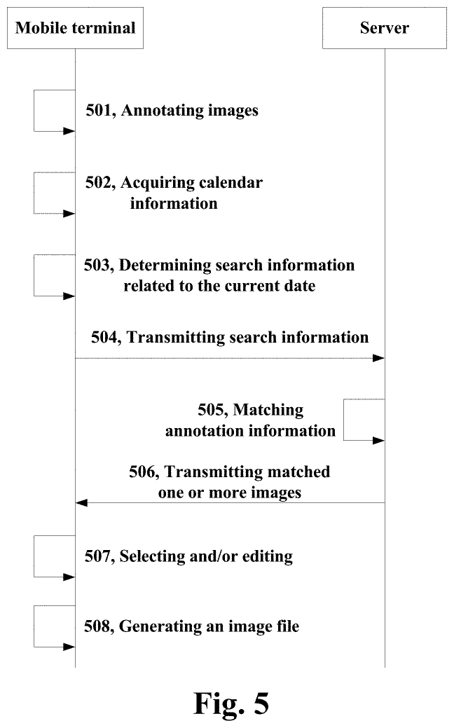

FIG. 5 is yet another schematic block diagram of the image forming method of the embodiment of this disclosure, in which an example of performing image search in the server (remotely) and generating an image file in the mobile terminal (locally) is shown. As shown in FIG. 5, the method includes:

step 501: annotating the images in the image library by the mobile terminal and/or the server;

for example, a father may be photographed by using the mobile terminal to obtain an avatar of the father and take “father” as annotation information of the avatar; at the server end, a part or all of the images may be annotated; in addition, a cloud image library may be located in the server, and image search is performed by the server; many photos or videos about the father, such as a photo of the user and the father, a single photo of the father, and a photo of family members, etc., may have been stored in the cloud image library; all these images may have been annotated, and the annotation information includes “father”; and of course, one image may be annotated with multiple key words;

step 502: acquiring the calendar information locally or from the server by the mobile terminal;

in an embodiment, the mobile terminal may be triggered at a predetermined moment to select an image according to the calendar information. For example, it is triggered to determine a current date at 7:00 am every day, and at 7:00 am on the third Sunday of June 2018, the mobile terminal may determine that the current date is the Father's Day according to the calendar information;

step 503: determining search information related to the current date by the mobile terminal according to the calendar information;

for example, if the current date is Father's Day of 2018, it may be determined that the search information related to the current date is “father”; for another example, if the current date is a mother's birthday of 2018, it may be determined that the search information related to the current date is “mother”; and for a further example, if the current date is the Dragon Boat Festival of 2018, it may be determined that the search information related to the current date is “Zongzi”. However, this disclosure is not limited thereto, and a date and search information may be associated as actually demanded;

step 504: transmitting the search information by the mobile terminal to the server;

step 505: matching the annotation information in the cloud image library by the server according to the search information so as to find one or more images to which annotation information matching with the search information corresponds;

for example, the search information determined in step 503 includes “father”, and if annotation information of an image in the cloud image library includes “father, Hokkaido, mother”, the image may be deemed as being matching with the search information as it includes “father”; hence, one or more images annotated with “father” may be matched in step 501, and reference may be made to related image annotation techniques for how to match;

step 506: transmitting one or more images to which the annotation information matching with the search information corresponds by the server to the mobile terminal;

step 507: receiving instruction information inputted by the user, and selecting and/or editing the one or more images, by the mobile terminal;

for example, in step 505, a plurality of photos of the user and the father may be found, and the mobile terminal may recommend a predetermined number (for example, three; however, it is not limited thereto) of images to the user according to a rule (such as a capture time, a capture location, and a capture parameter, etc.); the user may also select or replace these images, and furthermore, the user may edit them (such as adjusting brightness, and contrast, etc.);

step 508: generating the image file by the mobile terminal according to the one or more images and words and/or voices related to the current date inputted or preset by the user;

for example, the words and/or voices related to the current date inputted or preset by the user may include: words of “Happy Father's Day”, voice of “Happy Father's Day”, a favorite song of a father, and a song blessing a father, etc.; and the mobile terminal may synthesize these images, as well as these words and/or voices, and generate an electronic greeting card.

In the above embodiments, the mobile terminal and/or the server searches for one or more images, and the mobile terminal generates the image file (locally); however, this disclosure is not limited thereto, for example, the server may also generate the image file and transmit it to the mobile terminal (remotely).

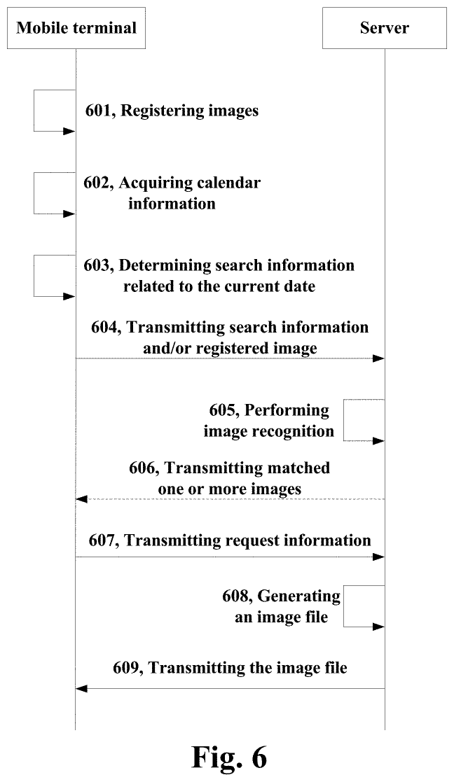

FIG. 6 is still another schematic block diagram of the image forming method of the embodiment of this disclosure, in which an example of performing image search and generating an image file in the server (remotely) is shown. As shown in FIG. 6, the method includes:

step 601: registering images, and associating the registered images with the search information, by the mobile terminal and/or the server;

step 602: acquiring the calendar information locally or from the server by the mobile terminal;

step 603: determining search information related to the current date by the mobile terminal according to the calendar information;

step 604: transmitting the search information by the mobile terminal to the server, and determining a corresponding registered image by the server according to the search information, or determining a corresponding registered image by the mobile terminal according to the search information and transmitting the registered image to the server;

step 605: performing image recognition by the server in the cloud image library according to the registered image so as to find one or more images matching with the registered image;

step 606: transmitting the one or more images matching with the registered image by the server to the mobile terminal;

step 607: receiving instruction information inputted by the user, and transmitting request information to the server, by the mobile terminal;

for example, the mobile terminal may display the one or more images to the user and inquiring the user of whether to generate a greeting card for the Father's Day; and after receiving an instruction from the user for acknowledging to generate a greeting card for the Father's Day, the mobile terminal may transmit request information for generating the image file to the server;

step 608: generating the image file by the server according to the one or more images and words and/or voices related to the current date inputted or preset by the user;

for example, the words and/or voices related to the current date inputted or preset by the user may include: words of “Happy Father's Day”, voice of “Happy Father's Day”, a favorite song of a father, and a song blessing a father, etc.; and the server may synthesize these images, as well as these words and/or voices, and generate an electronic greeting card;

step 609: transmitting the image file by the server to the mobile terminal.

In the example shown in FIG. 6, the server may transmit the one or more images to the mobile terminal for the user to acknowledge (step 606). However, this disclosure is not limited thereto; for example, step 606 may be omitted and the server may directly generate the image file and transmit it to the mobile terminal for the user to acknowledge. In addition, image registration is taken as an example for illustration in FIG. 6, and annotation information may also be used for searching, which shall not be described herein any further.

It should be noted that FIGS. 2-6 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIGS. 2-6.

After obtaining the image file, the mobile terminal may receive the instruction information inputted by the user and upload the image file to social software (such as SNS, WeChat, and Facebook, etc.); or may transmit the image file to the father (such as via an email address, and instant messaging software, etc.).

It should be noted that the above implementations only illustrate the embodiment of this disclosure. However, this disclosure is not limited thereto, and appropriate variants may be made to these implementation. For example, the above implementations may be executed separately, or one or more of them may be executed in a combined manner.

It can be seen from the above embodiment that the mobile terminal determines the search information related to a current date according to the calendar information, searches out one or more images from an image library according to the search information, and obtains an image file related to the current date according to the one or more images. Hence, the image file related to the current date may be actively generated according to the calendar information, and the mobile terminal may recommend and remind the current date to the user, thereby further improving user experiences.

### Embodiment of the Second Aspect

The embodiment of this disclosure provides an image forming apparatus, which may be, for example, a mobile terminal, or may be one or more components or assemblies (such as a function of an APP) configured in the mobile terminal, with contents identical to those in the embodiment of the first aspect being not going to be described herein any further.

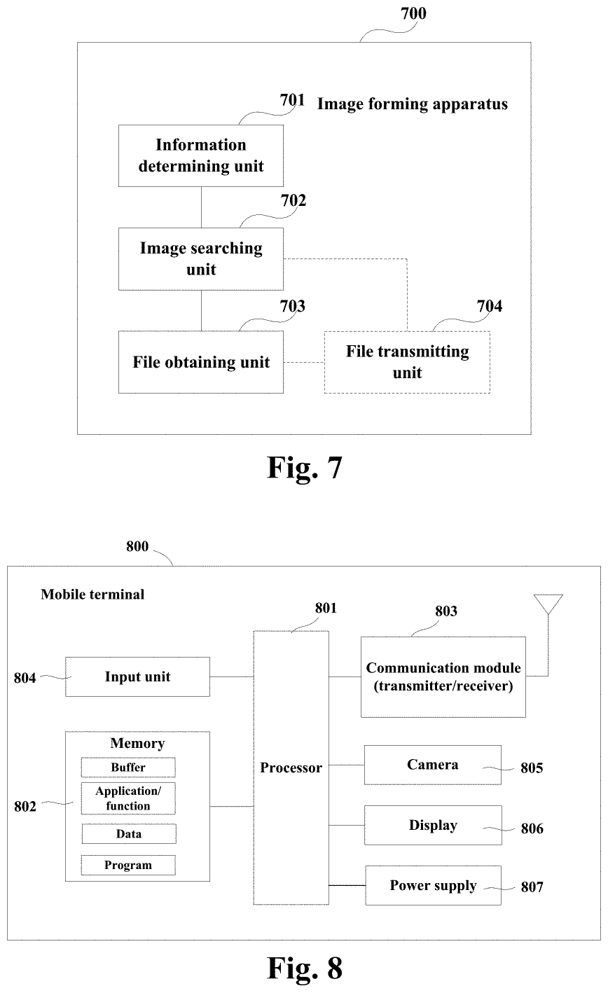

FIG. 7 is a schematic diagram of the image forming apparatus according to the embodiment of this disclosure. As shown in FIG. 7, the image forming apparatus 700 includes:

an information determining unit 701 configured to determine search information related to a current date according to calendar information;

an image searching unit 702 configured to search for one or more images from an image library according to the search information; and

a file obtaining unit 703 configured to obtain an image file related to the current date according to the one or more images.

As shown in FIG. 7, the apparatus 700 may further include:

a file transmitting unit 704 configured to receive instruction information inputted by a user, and transmit the image file to a file server, other mobile terminals, or a mail server.

It should be noted that the components or modules related to this disclosure are only described above. However, this disclosure is not limited thereto, and the image forming apparatus 700 may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, a receiver, and a display, etc., which are not limited in the embodiment of this disclosure.

It can be seen from the above embodiment that the mobile terminal determines the search information related to a current date according to the calendar information, searches out one or more images from an image library according to the search information, and obtains an image file related to the current date according to the one or more images. Hence, the image file related to the current date may be actively generated according to the calendar information, and the mobile terminal may recommend and remind the current date to the user, thereby further improving user experiences.

### Embodiment of the Third Aspect

The embodiment of this disclosure provides a mobile terminal, which may be a mobile phone, a tablet computer, a digital single lens reflex camera, a digital non-reflective camera, a portable digital camera, a media player, a portable game device, a PDA, and a computer, or the like, and this embodiment is not limited thereto.

FIG. 8 is a schematic diagram of a structure of the mobile terminal of the embodiment of this disclosure. As shown in FIG. 8, the mobile terminal 800 may include a processor 801 (such as a central processing unit (CPU)) and a memory 802, the memory 802 being coupled to the processor 801. Wherein, the memory 802 may store various data, and furthermore, it may store a program for data processing, and execute the program under control of the processor 801. It should be noted that this figure is illustrative only, and other types of structures may also be used, so as to supplement or replace this structure and achieve a telecommunications function or other functions.

For example, the processor 801 may be configured to execute a program to implement the image forming method as described in the embodiment of the first aspect. For example, the processor 801 may be configured to perform the following control: determining search information related to a current date according to calendar information; searching out one or more images from an image library according to the search information; and obtaining an image file related to the current date according to the one or more images.

In an embodiment, the processor 801 may further be configured to perform the following control: receiving instruction information inputted by a user, and transmitting the image file to a file server, other mobile terminals or an email server.

In an embodiment, the processor 801 may further be configured to perform the following control: acquiring the calendar information locally or from a server.

In an embodiment, the current date includes at least one of the following: a festival or a holiday of a region where the mobile terminal is located, a memorial day or a celebration day of a user of the mobile terminal, a festival or a holiday of a preset region, and a memorial day or a celebration day of a preset person.

In an embodiment, the image comprises at least one of the following: a static picture, a dynamic picture, and a video; and the image file comprises at least one of the following: a picture file, a video file, an electronic greeting card, and an electronic display file.

In an embodiment, the processor 801 may further be configured to perform the following control: registering an image to associate the registered image with the search information.

In an embodiment, the processor 801 may further be configured to perform the following control: determining a corresponding registered image by the mobile terminal according to the search information; and performing image recognition in the image library according to the registered image so as to find out one or more images matching with the registered image.

In an embodiment, the processor 801 may further be configured to perform the following control: transmitting the search information and/or the corresponding registered image to the server, so that the server performs image recognition in the image library according to the registered image to which the search information corresponds, so as to find out one or more images matching with the registered image; and receiving the one or more images matching with the registered image from the server.

In an embodiment, the processor 801 may further be configured to perform the following control: annotating images in the image library.

In an embodiment, the processor 801 may further be configured to perform the following control: matching annotation information in the image library according to the search information; and finding out one or more images corresponding to annotation information matching with the search information.

In an embodiment, the processor 801 may further be configured to perform the following control: transmitting the search information to the server, so that the server matches annotation information in the image library according to the search information, so as to find out one or more images to which annotation information matching with the search information corresponds; and receiving one or more images corresponding to the annotation information matching with the search information from the server.

In an embodiment, the processor 801 may further be configured to perform the following control: receiving instruction information inputted by the user, and selecting and/or editing the one or more images; and generating the image file according the one or more images and words and/or voices related to the current date that are inputted by the user or predetermined.

In an embodiment, the processor 801 may further be configured to perform the following control: transmitting request information to the server, so that the server generates the image file according to the one or more images; and receiving the image file related to the current date from the server.

As shown in FIG. 8, the mobile terminal 800 may further include a communication module 803, an input unit 804, a camera 805, a display 806, and a power supply 807.

The processor 801 (sometimes referred to as a controller or an operational control, which may include a microprocessor or other processor devices and/or logic devices) receives input and controls various parts and operations of the mobile terminal 800. The input unit 804 provides input to the processor 801. The input unit 804 is, for example, a button, or a touch input device. The camera 808 is used for capturing image data and providing the captured image data to the processor 801 for use in a conventional manner, such as for storage, transfer, and the like.

The power supply 807 is used for providing power to the mobile terminal 800. The display 806 is used to display a displayed object, such as an image, and a character. The display may be, for example, an LCD display or an LED display; however, it is not limited thereto, and it may also be other types of displays that are currently available or will exist in the future.

The memory 802 may be a solid state memory such as a read only memory (ROM), a random access memory (RAM), a SIM card, or the like. It may also be a memory that retains information even when the power is turned off, and can be selectively erased and provided with more data, and an example of this memory is sometimes referred to as an EPROM, or the like. The memory 802 may also be a device of another type. The memory 802 includes a buffer memory (sometimes referred to as a buffer). The memory 802 may include an application/function storage portion for storing applications and function programs or a flow for performing operations of the mobile terminal 800 by the processor 801.

The memory 802 may further include a data storage portion for storing data, such as contacts, digital data, pictures, sounds, and/or any other data used by the mobile terminal 800. A driver storage portion of the memory 802 may include various drivers of the mobile terminal for communications functions and/or for performing other functions of the mobile terminal (such as messaging applications, address book applications, etc.).

The communication module 803 is a transmitter/receiver that transmits and receives signals via an antenna. The communication module (transmitter/receiver) 803 is coupled to the processor 801 to provide an input signal and receive an output signal, which may be the same as in the case of a conventional mobile communication terminal. Based on different communication technologies, in the same electronic device, a plurality of communication modules 803, such as a cellular network module, a Bluetooth module, and/or a wireless local area network module, etc., may be provided to implement usual telecommunications functions.

It should be noted that FIG. 8 only schematically shows a part of the structure of the mobile terminal 800, and the mobile terminal 800 does not necessarily include all the components shown in FIG. 8; and furthermore, the mobile terminal 800 may include parts not shown in FIG. 8, and reference may be made to the prior art.

An embodiment of this disclosure provides a computer readable program code, which, when executed in a mobile terminal, will cause the mobile terminal to carry out the image forming method described in the embodiment of the first aspect.

An embodiment of this disclosure provides a computer readable medium, including a computer readable program code, which will cause a mobile terminal to carry out the image forming method described in the embodiment of the first aspect.

The preferred embodiments of the present disclosure are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present disclosure may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of comprising one or more modules, segments or parts for realizing the codes of executable instructions of the steps in specific logic functions or processes, and that the scope of the preferred embodiments of the present disclosure comprise other implementations, wherein the functions may be executed in manners different from those shown or discussed, including executing the functions according to the related functions in a substantially simultaneous manner or in a reverse order, which should be understood by those skilled in the art to which the present disclosure pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present disclosure. It should be understood that a person of ordinary skill in the art may prepare suitable computer codes to carry out each of the steps and processes described above and illustrated in the drawings. It should also be understood that the above-described terminals, computers, servers, and networks, etc. may be any type, and the computer codes may be prepared according to the disclosure contained herein to carry out the present disclosure by using the devices.

Particular embodiments of the present disclosure have been disclosed herein. Those skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present disclosure has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present disclosure with respect to structure. Furthermore, although a particular feature of the present disclosure is described with respect to only one or more of the illustrated embodiments, such a feature may be combined with one or more other features of other embodiments as desired and in consideration of advantageous aspects of any given or particular application.

1. An image forming method, comprising:
determining search information related to a current date by a mobile terminal according to calendar information;
searching out one or more images from an image library by the mobile terminal according to the search information; and
obtaining an image file related to the current date by the mobile terminal according to the one or more images.

2. The method according to claim 1, wherein the method further comprises:
receiving, by the mobile terminal, instruction information inputted by a user, and
transmitting the image file by the mobile terminal to a file server, other mobile terminals or an email server.

3. The method according to claim 1, wherein the method further comprises:
acquiring the calendar information by the mobile terminal locally or from a server.

4. The method according to claim 1, wherein the current date includes at least one of the following: a festival or a holiday of a region where the mobile terminal is located, a memorial day or a celebration day of a user of the mobile terminal, a festival or a holiday of a preset region, and a memorial day or a celebration day of a preset person.

5. The method according to claim 1, wherein the image comprises at least one of the following: a static picture, a dynamic picture, and a video;
and the image file comprises at least one of the following: a picture file, a video file, an electronic greeting card, and an electronic display file.

6. The method according to claim 1, wherein the method further comprises:
registering an image by the mobile terminal and/or the server to associate the registered image with the search information.

7. The method according to claim 6, wherein the searching out one or more images from an image library by the mobile terminal according to the search information comprises:
determining a corresponding registered image by the mobile terminal according to the search information; and
performing image recognition in the image library according to the registered image so as to find out one or more images matching with the registered image.

8. The method according to claim 6, wherein the searching out one or more images from an image library by the mobile terminal according to the search information comprises:
transmitting the search information and/or the corresponding registered image by the mobile terminal to the server, so that the server performs image recognition in the image library according to the registered image to which the search information corresponds, so as to find out one or more images matching with the registered image; and
receiving the one or more images matching with the registered image by the mobile terminal from the server.

9. The method according to claim 1, wherein the method further comprises:
annotating images in the image library by the mobile terminal and/or the server.

10. The method according to claim 9, wherein the searching out one or more images from an image library by the mobile terminal according to the search information comprises:
matching annotation information in the image library by the mobile terminal according to the search information; and
finding out one or more images corresponding to annotation information matching with the search information.

11. The method according to claim 9, wherein the searching out one or more images from an image library by the mobile terminal according to the search information comprises:
transmitting the search information by the mobile terminal to the server, so that the server matches annotation information in the image library according to the search information, so as to find out one or more images to which annotation information matching with the search information corresponds; and
receiving one or more images corresponding to the annotation information matching with the search information by the mobile terminal from the server.

12. The method according to claim 1, wherein the obtaining an image file related to the current date by the mobile terminal according to the one or more images comprises:
receiving instruction information inputted by the user, and selecting and/or editing the one or more images, by the mobile terminal; and
generating the image file according the one or more images and words and/or voices related to the current date that are inputted by the user or predetermined.

13. The method according to claim 1, wherein the obtaining an image file related to the current date by the mobile terminal according to the one or more images comprises:
transmitting request information by the mobile terminal to the server, so that the server generates the image file according to the one or more images; and
receiving the image file related to the current date by the mobile terminal from the server.

14. An image forming apparatus, comprising:
a memory that stores a plurality of instructions; and
a processor coupled to the memory and configured to execute the instructions to:
determine search information related to a current date according to calendar information;
search out one or more images from an image library according to the search information; and
obtain an image file related to the current date according to the one or more images.

15. The apparatus according to claim 14, wherein the processor further configured to execute the instructions to:
receive instruction information inputted by a user, and transmit the image file to a file server, other mobile terminals or an email server.

16. A mobile terminal, comprising a memory and a processor, the memory storing instructions executed by the processor, and the processor being configured to ions.
determine search information related to a current date according to calendar information;
search out one or more images from an image library according to the search information; and
obtain an image file related to the current date according to the one or more images.

17.-18. (canceled)
